(19) United States
(12) Patent Application Publication
(10) Pub. No.: US 2002/0078461 A1
(43) Pub. Date: Jun. 20, 2002

(54) Incasting for downloading files on distributed networks

(76) Inventor: Patrict Oscar Boykin, Raleigh, NC (US)

Correspondence Address: W. Edward Johansen, 11661 San Vincente Boulevard, Los Angeles, CA, 90049, US

(21) Appl. No.: 09/737,458

(22) Filed: Dec. 14, 2000

(51) Int. Cl. H04N 7/173

(52) U.S. Cl. 725/87; 725/92; 725/93

(57) ABSTRACT

A distributed network includes a plurality of hosts and a shared communication channel. Each host has a storage device. Each host may act as a client and a server. A file is divided into a plurality of segments. Each segment is transmitted to the storage devices of several of said hosts and stored in said storage device of said host. Each host is coupled to the shared communication channel. A host acting as a client requests that the hosts act as servers and collectively send all of the segments to the requesting client so that the requesting client can gather the segments together in order for the segments to self-assemble and generate a single copy of the file. At least one host has a global list with entries. Each entry contains all the necessary information about the file.

### BACKGROUND OF THE INVENTION

The present invention relates to a data storage/access in a client-server system which consists of a plurality of hosts each of which may act as either a server or clients and which are interconnected by a shared communication channel.

Research and development have been achieved on a server with a storage device for storing a number of files, such as a movie. The server distributes these files upon a demand from a client.

A video server system needs extension due to lack of capacity of server computers, it has been solved by replacing the old ones with a higher performance server computer, or by increasing the number of server computers so that a load of processing is distributed over a plurality of server-computers. The latter way of extending the system by increasing the number of server computers is effective in terms of workload and cost. A video server as such is introduced in “A Tiger of Microsoft, United States, Video on Demand” in an extra volume of Nikkei Electronics titled “Technology which underlies Information Superhighway in the United States”, pages 40, 41 published in Oct. 24, 1994 by Nikkei BP.

A server system includes a network and server-computers. The server-computers are connected to the network and have a function as a video server, magnetic disk unit which are connected to the server computers and stores video programs, clients which are connected to the network and demand the server computers to read out a video program. Each server computer has a different plurality of set of video programs such as a movie stored in the magnetic disk units. A client therefore reads out a video program via one of the server-computers which has a magnetic disk units where a necessary video program is stored. The server system in which each one of a plurality of server-computers stores an independent set of video programs. The server system is utilized efficiently when each demand on a video program is distributed to different server computers. However when a plurality of accesses rush into a certain video program, a work load increases on a server computer where this video program is stored, namely a work load disparity will be caused among server computers. Even if the other server computers remain idle, the whole capacity of the system has reached to the utmost level because of the overload on a capacity of a single computer. This deteriorates the efficiency of the server system.

U.S. Pat. No. 5,630,007 teaches a client-server system which includes a plurality of servers and a plurality of storage devices. The storage devices sequentially store data. The data is distributed in each of the plurality of storage devices. Each server device is connected to the plurality of storage devices for accessing the data distributed and stored in each of the plurality of storage devices. The client-server system improves efficiency of each server by distributing loads to a plurality of servers. The client-server system also includes an administration apparatus. The administration apparatus is connected to the plurality of servers for administrating the data sequentially stored in the plurality of storage devices and the plurality of servers. A client is connected to both the administration apparatus and the plurality of servers. The client specifies a server that is connected to a storage device where a head block of the data is stored by inquiring to the administration apparatus and accesses the data in the plurality of servers according to the order of the data storage sequence from the specified server. The client makes an inquiry to the administration apparatus and accesses the data in the plurality of servers in accordance to the order of the data storage sequence from the specified server.

U.S. Pat. No. 5,905,847 teaches a client-server system which improves efficiency of each server by distributing loads to a plurality of servers having a plurality of storage devices. The storage devices sequentially store data. The data is distributed in each of the plurality of storage devices. Each server is connected to the plurality of storage devices for accessing the data distributed and stored in each of the plurality of storage devices. An administration apparatus is connected to the plurality of servers for administrating the data sequentially stored in the plurality of storage devices and the plurality of servers. A client is connected to both the administration apparatus and the plurality of servers. The client specifies a server which is connected to a storage device in which a head block of the data is stored by making an inquiry to the administration apparatus and accesses the data in the plurality of servers in accordance to the order of the data storage sequence from the specified server.

U.S. Pat. No. 5,926,101 teaches a multi-hop broadcast network of nodes which have a minimum of hardware resources, such as memory and processing power. The network is configured by gathering information concerning which nodes can communicate with each other using flooding with hop counts and parent routing protocols. A partitioned spanning tree is created and node addresses are assigned so that the address of a child node includes as its most significant bits the address of its parent. This allows the address of the node to be used to determine if the node is to process or resend the packet so that the node can make complete packet routing decisions using only its own address.

U.S. Pat. No. 6,108,703 teaches a network-architecture which has a framework. The framework supports hosting and content distribution on a truly global scale. The framework allows a content provider to replicate and serve its most popular content at an unlimited number of points throughout the world. The framework includes a set of servers operating in a distributed manner. The actual content to be served is preferably supported on a set of hosting servers (sometimes referred to as ghost servers). This content includes HTML page objects that are served from a content provider site. A base HTML document portion of a Web page is served from the content provider's site while one or more embedded objects for the page are served from the hosting servers, preferably, those hosting servers near the client machine. By serving the base HTML document from the content provider's site, the content provider maintains control over the content.

U.S. Pat. No. 5,367,698 teaches a networked digital data processing system which has two or more client devices and a network. The network includes a set of interconnections for transferring information between the client devices. At least one of the client devices has a local data file storage element for locally storing and providing access to digital data files arranged in one or more client file systems. A migration file server includes a migration storage element that stores data portions of files from the client devices, a storage level detection element that detects a storage utilization level in the storage element, and a level-responsive transfer element that selectively transfers data portions of files from the client device to the storage element.

U.S. Pat. No. 5,802,301 teaches a method for improving load balancing in a file server. The method includes the steps of determining the existence of an overload condition on a storage device having a plurality of retrieval streams, accessing at least one file thereon, selecting a first retrieval stream reading a file, replicating a portion of the file being read by the first retrieval stream onto a second storage device and reading the replicated portion of the file on the second storage device with a retrieval stream capable of accessing the replicated portion of the file. The method enables the dynamic replication of data objects to respond to fluctuating user demand. The method is particularly useful in file servers such as multimedia servers delivering continuously in real time large multimedia files such as movies.

U.S. Pat. No. 5,542,087 teaches a data processing method which generate a correct memory address from a character or digit string such as a record key value and which is adapted for use in distributed or parallel processing architectures such as computer networks, multiprocessing systems, and the like. The data processing method provides a plurality of client data processors and a plurality of file servers. Each server includes at least a respective one memory location or “bucket”. The data processing method includes the steps of generating a key value by means of any one of the client data processors and generating a first memory address from the key value. The first address identifies a first memory location. The data processing method also includes the steps of selecting from the plurality of servers a server that includes the first memory location, transmitting the key value from the one client to the server that includes the first memory location and determining whether the first address is the correct address by means of the server. The data processing method further provides that if the first address is not the correct address then performing the steps of generating a second memory address from the key value by means of the server, the second address identifying a second memory location, selecting from the plurality of servers another server which includes the second memory location, transmitting the key value from the server that includes the first memory location to the other server which includes the second memory location, determining whether the second address is the correct address by means of the other server and generating a third memory address, which is the correct address, if neither the first or second addresses is the correct address. The data processing method provides fast storage and subsequent searching and retrieval of data records in data processing applications such as database applications.

Distributed storage and sharing of data and program files has become an integral part of doing business over the Internet and other distributed networks. Such a distributed environment is characterized by the fact that multiple copies of the same file reside over the network.

In peer-to-peer networking each user also doubles as a server connected to the Internet. Service providers, such as Napster, Gnutella and Freenet have emerged. This emerging technology has the potential to revolutionize Internet and E-Commerce, but several technological challenges have to be overcome before it can be translated into a robust product which hundreds of millions of customers can reliably use.

The most frequent use of such a network is for downloading purposes. A client looks up the content list, and wants to download a particular file/content from the network. The existing protocols for this process are extremely simple and can be described in general as follows. The client or a central server searches the list of servers that contain the desired file, and picks one such server (either randomly or according to some priority list maintained by the central server) and establishes a direct connection between the client requesting the down load and the chosen server. This connection is maintained until the entire file has been transferred. The exact implementation might vary from one protocol to another; however, the fact that only one server is picked for the transfer of the entire requested file remains invariant.

The above-mentioned existing protocols suffer from several serious drawbacks, as stated next. Since only one server is picked for the transfer of the entire file (even though there are potentially many servers with the same content), the quality of service becomes totally dependent on the bandwidth and the reliability of the Internet access that the chosen server maintains during the transfer. This poses a serious problem, especially in the case of networks that primarily comprise of low-performance servers as is the case for Napster and other proposed peer-to-peer networks and the reliability and speed of the host computers cannot be guaranteed. The average available bandwidth could be as low as that of a 28.8K or a 56K modem. Moreover, the connection of the server to the Internet could be dropped in the middle of a download, necessitating another attempt from the beginning. For example, an average MP3 file is around 5 Mega-bytes in length, and it will take around 16-20 minutes to download it over a 56K modem!! If the connection is dropped at any time during this period, then one needs to attempt the download all over again. The issue of choosing the best server among those that have a copy of the requested file is not properly addressed, leading to a further loss in the quality of the service. If the winner is picked randomly then clearly it is not the best choice. Even if the winner is picked based on a pre-sorted list, where servers are ranked according to their average available bandwidth, the resulting scheme would be far from optimal. In particular, even if a server has a higher average bandwidth, since it comprises only a part of the host computer and shares the bandwidth with other competing tasks, the available bandwidth for the download could be drastically low during the time of the transfer. The protocols do not take advantage of the fact that the client could have a much higher available bandwidth than any of the potential servers. For example, even if the client is connected to a high-speed Ethernet, the effective transfer rate for the session could still be as low as that of a modem that the chosen server might be using. Accuracy and integrity of the downloaded file are not usually guaranteed. Since multiple copies of the files are maintained by different servers the issue of the integrity of the downloaded files becomes a serious concern.

The inventor incorporates the teachings of the above-cited patents into this specification.

### SUMMARY OF THE INVENTION

The present invention is generally directed to a distributed network which includes a plurality of hosts and a shared communication channel. Each hosts is coupled to the shared communication channel. Each host acts as both a client and a server.

In a first separate aspect of the present invention, the distributed network is used to incast fragments from multiple copies of a file in order to be gathered together so that a single copy of the file can be generated.

In a second separate aspect of the present invention, at least one host has a global list with entries. Each entry contains all the necessary information about a file.

The features of the present invention which are believed to be novel are set forth with particularity in the appended claims.

### DESCRIPTION OF THE DRAWINGS

FIG. 1 is a schematic diagram of a video server system of the prior art.

FIG. 2 is a schematic diagram of a video server system of U.S. Pat. No. 5,630,007.

FIG. 3 is a schematic diagram of an administration table according to U.S. Pat. No. 5,630,007.

FIG. 4 is a schematic drawing a distributed network which has a plurality of hosts according to the present invention wherein each host acts as both a client and a server.

FIG. 5 is a schematic drawing of a file format for use in the distributed network of FIG. 4.

FIG. 6 is a schematic drawing of an entry for a file in a global list in which the entry contains all the necessary information about the file so that a client can successfully complete an incasting process using the distributed network of FIG. 4.

### DESCRIPTION OF THE PREFERRED EMBODIMENT

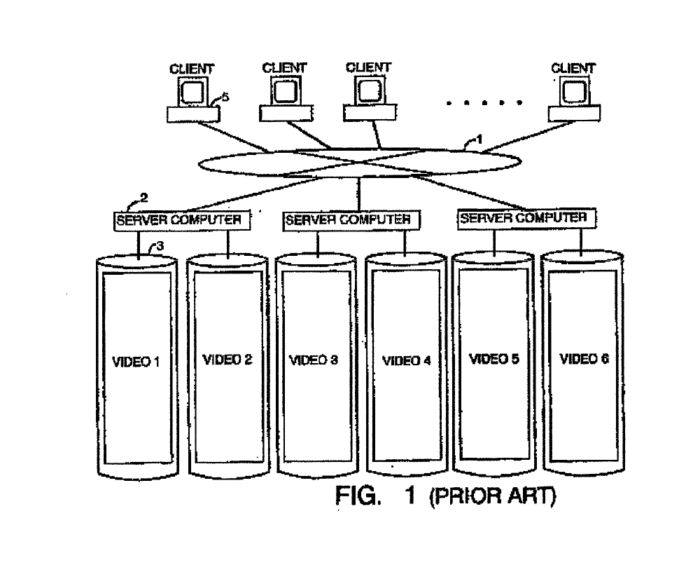

FIG. 1 is a video server system of the prior art includes a network 1 and server computers 2. The server computers 2 are connected to the network 1 and have a function as a video server, magnetic disk unit 3 which are connected to the server computers 2 and stores video programs, clients 5 which are connected to the network 1 and demand the server computers 2 to read out a video program. Each server computer 2 has a different plurality of set of video programs such as a movie stored in the magnetic disk units 3. A client 5 therefore reads out a video program via one of the server computers 2 which has a magnetic disk units 3 where a necessary video program is stored.

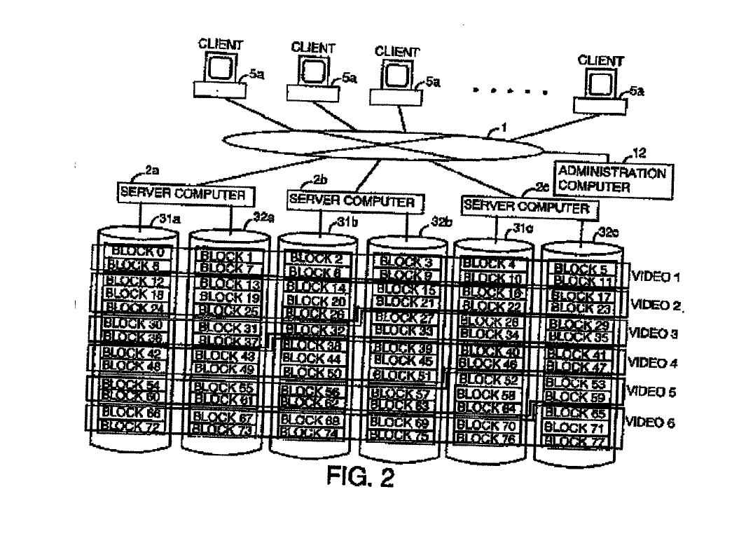

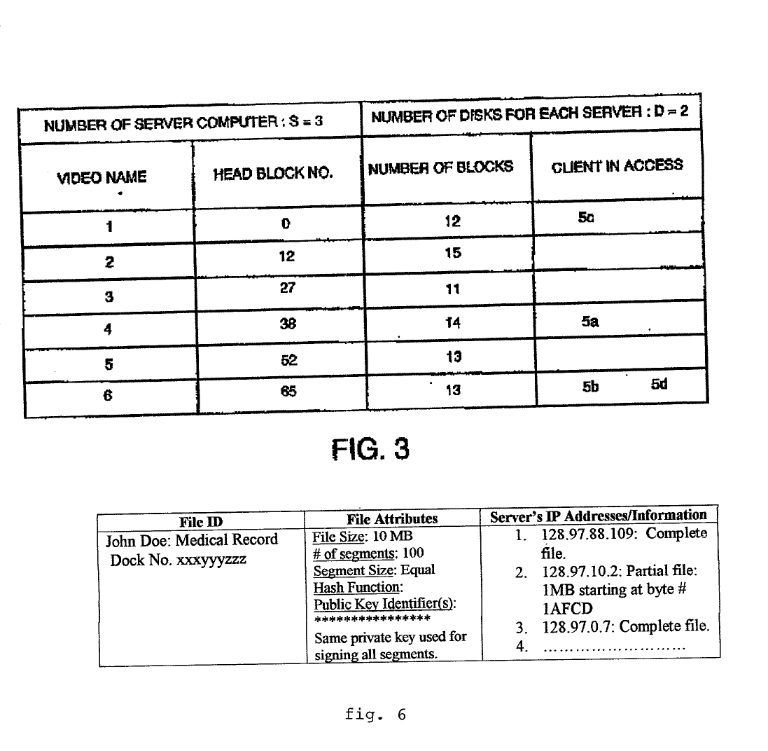

Referring to FIG. 2 in conjunction with FIG. 3 a video server system 10 of U.S. Pat. No. 5,630,007 includes a network 11, such as Ethernet and ATM, and a plurality of server computers 12. Application programs are connected to the network 11. Magnetic disk units 31 and 32 are connected to the server computers which sequentially store distributed data, such as a video program, which has been divided (referred to as “striping”) to be stored in the magnetic disk units 31 and 32, client computers 5 which are connected to the network 1 and receive video program, application programs which operate in the client computers 5, driver programs as an access demand means which demand access to the video program 4 having been divided and sequentially stored in magnetic disk units 31 and 32 in response to a demand to access from application programs. Client-side network interfaces carry out such process as TCP/IP protocol in the client computers 5 and realize interfaces between clients and the network 1, server-side network interfaces which carry out such processes as TCP/IP protocol in the server computers 2 and realizes interface between servers and the network 1, server programs which read data block out of magnetic disk units 31 and 32 to supply it to the server-side network interfaces the original video program 11 which has not yet been divided nor stored, administration computer 12 connected to the network 1, administration program 13 operated in the administration computer 12 which administrates the video program having been divided and stored in magnetic disk units 31 and 32 and the server computers 2. The administration computer-side network interface carries out such process as TCP/IP protocol in the administration computer 12 and realizes an interface between the administration computer 12 and the network 1, and a large capacity storage 15 such as CD-ROM, which is connected to the computer 12 and the original video program 11 is stored therein.

Still referring to FIG. 2 only two magnetic disk units are connected to each server computer. Each of the three server computers 2 is connected to two magnetic disk units, respectively, and also connected to the administration computer 12 and a plurality of client computers 5 which are devices on the video-receiving side, via the network 1. Each magnetic disk unit 31 or 32 is divided into block units per a certain amount. Six video programs, denoted by videos 1˜6 are stored in 78 blocks denoted by blocks 0˜77. Each video program is stored as if data was striped where data has been divided and distributed over the plurality of the magnetic disk units 31 and 32. Video 1 is sequentially stored in the blocks 0˜11, and video 2 is sequentially stored in the blocks 12˜26. Videos 3˜6 are also stored in the blocks, respectively.

Referring to FIG. 4 a distributed network 110 includes a plurality of hosts 111 and a shared communication channel 112. Each host is coupled to the shared communication channel 112. Each host 111 may act as both a client and a server and uses the distributed network 110, but not all of the hosts need to act as either a client or a server. The downloading process may be called incasting because it can be construed as a reverse of broadcasting. In broadcasting, a file 120 is transmitted to multiple locations generating multiple copies of the file 120. In contrast, in incasting fragments 121 of multiple copies of the file 120 are gathered together to generate a single copy of the file 120. There is a format for creating and storing multiple copies of the files 120 and a protocol to guarantee fast in the sense that it utilizes the maximum available bandwidth for the task and accurate transfer of the requested content/file 120 to a client in the sense that the content of the copied file 120 is the same as that of the stored one. Incasting would constitute the backbone of the distributed network 110.

Incasting addresses a key technological issue of how to provide a high-quality service in terms of both accuracy and speed for transferring a file 120, which a client has requested, to the client on the distributed network 110 that support content replication. The same content or file 120 can reside in several different servers on the distributed network 110. This could be either because the file 120 was created at only one server and then distributed to several others or because the same content was created or procured independently at different servers.

Incasting will work even if no individual server has the complete file 120, but as long as the complete file 120 is collectively available on the whole distributed network 110. There is a unique identification tag for each content or file 120 residing on the network. A list of all accessible content/files 120 is either available from one central server or is maintained in a distributed manner. Several servers may contain a complete or partial lists of the contents. Such a list would contain the identification tags of all the contents. For each content/file 120 it would list all the servers that contain a copy of the file 120.

Referring to FIG. 5 the file 120 is divided into a number of segments 121. Each segment 121 has a secure hash function. The secure hash function is used to compute a message digest, which is then signed. The number of segments 121, their locations, the hash function(s) and the public key(s) for the digital signatures are recorded as attributes of the file 120.

The incasting process will work for any existing format for storing files 120 which follows the convention of being byte aligned. Hence, any server can handle a request, where it is asked to transmit blocks of bytes along with start and end indices. For example, a typical request could be for the transmission of M bytes of a file 120 starting at the kth byte. However, for guaranteeing the integrity of the files 120 and for avoiding expensive retransmissions of potentially erroneous downloads, the following format for storing files 120 and partitioning the file 120 into a specified number of segments 121 is recommended. For each segment 121, compute a message digest of the contents using a secure hash function. The message digest basically acts as a unique identifier for the contents of the segment 121 and on reception, can be used to guarantee the integrity of the contents of the segment 121. In order to guarantee authenticity (e.g., the fact that the file 120 was indeed created by the owner), one can in addition sign the digest. Thus, if one has the segment 121, the message digest and the digital signature of the file 120, then one can verify authenticity (check that the signature matches the digest) and then check for integrity (i.e., the digest matches the contents of the segment 21). For example, the Secure Hash Standard (SHS) can be used to generate 160-bit message digests for the segments 121. The Digital Signature Standard (DSS) can then be used to generate a 320-bit digital signature of the digest. Other standard hash functions (e.g., MD4 and MD5) and digital signature schemes (e.g., those based on RSA) can be used as well. The number of segments 21 and their starting locations can be stored in the file description. Moreover, if the feature of digital signature is used, then the public key(s) of the owner of the file 20 and the hash function used should also be made available in the description of the files 120.

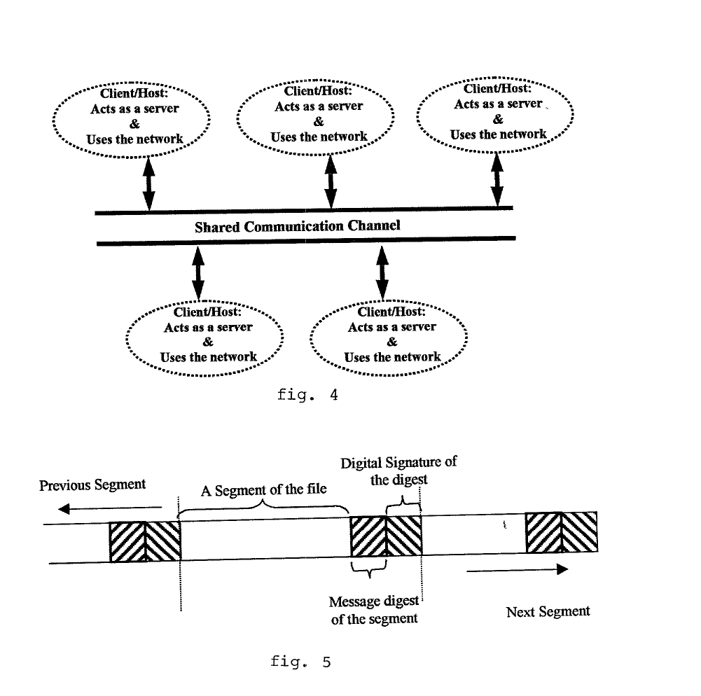

Referring to FIG. 6 each entry for a file 120 in a global list 130 contains all the necessary information about the file 120 so that a client can successfully complete an incasting process. The client wishing to download a file 120 goes through the following step of searching the distributed network 110. The client first searches the global list(s) 130 of content/files 120 (to be referred to as the network directory from hereon) to determine the availability of the desired file 120 on the distributed network 110. It is not necessary that a global network directory be maintained at one or several servers. The network directory could itself be maintained in a distributed fashion (e.g., the scheme adopted in the Gnutella network) in which case, a distributed search for the desired content/file 120 will be carried out. In both cases, the following information is returned to the client. A list of (IP) addresses for the servers where the file 120 is located partially or in full. If a server has only parts of the desired file 120, then a succinct description (e.g., start and end byte numbers of contiguous portions of the file 120) of the content stored in the server is also included. If the file 120 is divided into segments 21 along with corresponding digest and digital signature, then the client will also receive descriptions of the segments 21, and the types of hash functions and public key(s) used for the digital signature. The client now has all the storage information about the desired file 20, but does not know the exact availability of bandwidth at the eligible servers for any download request. Using an adaptive incasting algorithm the client is able to virtually segments the file 120 into a number of distinct parts and requests each part from a distinct server. The exact nature of the virtual segmentation procedure will depend on a number of factors, including, the bandwidth available to the client, any prior knowledge about the bandwidth available to different servers and also the storage format of the requested file 120. Since, these are all very implementation-dependent, specific details of the virtual segmentation procedure are not provided. Different servers will respond at different time intervals to the above-mentioned requests. For example, the servers that have high available bandwidth will respond faster than those with slower access, and some servers might not respond at all. The client can then have an online estimate of the traffic and can change the frequency and size of the requests adaptively. Some servers that do not respond during a pre-specified time interval could dropped from the list altogether or could be tried again after an interval of time, if the other active servers are not fast enough. This scheme allows complete flexibility and can be used to saturate the available bandwidth of the client. As the above-mentioned adaptive protocol is carried out, the desired file 20 is received in contiguous chunks of bytes. Since the segmentation format of the file 120 is known to the client, it can always check whether any complete segment 21 of the file 120 has been downloaded or not. Once a full segment 121 of the file 120 is downloaded, it can first verify authenticity of the message digest using the digital signature and the public key and then verify the accuracy/integrity of the segment 121 by comparing the downloaded message digest with a digest that it computes on the content of the segment 121 (using a pre-specified hash function). If any of these verification procedures fails, then it discards the whole segment 121 and starts the requests for the bytes in that segment 121 again. Clearly, there is a tradeoff here between the number of original segments 121 in the file 120 and the number of bytes that might be downloaded multiple times. If there are more segments 121 in the file 120, then first the chance that a segment 121 is corrupted is small, and second even if some bytes are corrupted then only a small number of bytes will need to be downloaded again. However, more segments 121 would mean a larger overhead in terms of the total size of the file 120. For example, if the Digital Signature Standard is used, then each segment 121 has to have at least an additional 60 bytes: 160 bits (20 bytes) for the message digest and 320 bits (40 bytes) for the digital signature.

Incasting allows a client to efficiently download a file 120 from the distributed network 110 by putting together fragments of the file 120 obtained from different servers that maintain partial or complete copies of the desired file 120. While the well-known broadcasting procedure creates copies of the same file 120 at many different destination servers incasting recreates a copy of the file 120 by optimally piecing together fragments of the file 120 obtained from multiple target servers. Incasting provides both a suitable format for storing the files 120 and a protocol for gathering the distributed content to create an accurate copy. The same content/file 120 can reside in several different servers on the distributed network 110. This could be either because, the file 120 was created at only one server, and then distributed to several others, or because the same content was created or procured independently at different servers. In fact, our invention will work even if no individual server has the complete file 120, but as long as the complete file 120 is collectively available on the whole distributed network 110. There is a unique identification tag for each content or file 120 residing on the network. A list of all accessible content/files 120 is either available from one central server, or is maintained in a distributed manner (i.e., several servers contain the complete or partial lists of the contents). Such a list would contain the identification tags of all the contents, and for each content/file 120 it would list all the servers that contain a copy of the file 120.

The most frequent use of the distributed network 10 is for downloading purposes. A client looks up the content list, and wants to download a particular content/file 20 from the distributed network 10. The existing protocols for this process are extremely simple, and can be described in general as follows. The client or a central server searches the list of servers that contain the desired file 20 and picks one such server (either randomly or according to some priority list maintained by the central server) and establishes a direct connection between the client requesting the down load and the chosen server. This connection is maintained until the entire file 20 has been transferred. The exact implementation might vary from one protocol to another; however, the fact that only one server is picked for the transfer of the entire requested file 120 remains invariant.

The distributed network includes a plurality of hosts and a shared communication channel. Each host has a storage device. U.S. Pat. No. 5,630,007 teaches a distributed network which includes a plurality of servers with storage devices and a plurality of clients. In U.S. Pat. No. 5,630,007 the servers are distinct from the clients. In this invention the clients and the servers are interchangeable. Each host may act as either a client or a server. A file is divided into a plurality of segments. Each segment is transmitted to the storage devices of several of the hosts and stored in the storage device of the host. Each host is coupled to the shared communication channel. A host acting as a client requests that the other hosts acting as servers and collectively send all of the segments to the requesting client so that the requesting client can gather the segments together in order for the segments to self-assemble and generate a single copy of the file. At least one host has a global list with entries. Each entry contains all the necessary information about the file.

From the foregoing it can be seen that incasting for downloading files 120 on distributed networks 110 has been described.

Accordingly it is intended that the foregoing disclosure and drawings shall be considered only as an illustration of the principle of the present invention.

What is claimed is:

1. A distributed network comprising:
a. a plurality of hosts each of which has a storage device and each of which may act as a client and a server;
b. a file which is divided into a plurality of segments wherein each segment is transmitted to said storage devices of several of said hosts and stored in said storage device of said host;
c. a shared communication channel to which each of said hosts is coupled whereby one of said host acting as a client requests that said hosts acting as servers and collectively send all of said segments to said requesting client so that said requesting client can gather said segments together in order for said segments to self-assemble and generate a single copy of said file.

2. A distributed network according to claim 1 wherein at least one host has a global list with entries each of which contains all the necessary information about said file.
